(19) United States
(12) Patent Application Publication
(10) Pub. No.: US 2025/0371164 A1
(43) Pub. Date: Dec. 4, 2025

(54) GENERATION AND APPLICATION OF SYNTHETIC THREAT DATA

(71) Applicant: Royal Bank of Canada, Toronto (CA)

(72) Inventors: Adam Hulcoop, Whitby (CA); Felix Kurmish, Nepean (CA)

(21) Appl. No.: 19/221,193

(22) Filed: May 28, 2025

Related U.S. Application Data
(60) Provisional application No. 63/654,590, filed on May 31, 2024.

(51) Int. Cl. G06F 21/57; G06F 21/53; G06F 21/56

(52) U.S. Cl. CPC G06F 21/577; G06F 21/53; G06F 21/56

(57) ABSTRACT

A method for detecting computer vulnerabilities comprises automatically generating synthetic threat data representative of malicious activity, injecting the synthetic threat data into genuine data to create a composite data stream, observing a protective model monitoring the composite data stream, and responsive to determining a failure by the protective model to detect the synthetic threat data, flagging the failure as a vulnerability. The synthetic threat data may be generated by automatically generating a plurality of pseudo-malicious agents, infecting virtual machines connected to a simulated network with the pseudo-malicious agents, and collecting simulated network traffic from the infected virtual machines, where the simulated network traffic contains communications from the pseudo-malicious agents.

### CROSS-REFERENCE TO RELATED APPLICATION

This application claims priority to, and the benefit of, United States Provisional Application No. 63/654,590 filed on May 31, 2024, the teachings of which are hereby incorporated by reference.

### TECHNICAL FIELD

The present disclosure relates to computer security, and more particularly to the detection of vulnerabilities in computer security.

### BACKGROUND

The term “malware” is a contraction of “malicious software” which, as its name suggests, is intrusive software that is intended to achieve a malevolent end, such as exfiltration of data, surveillance, or commandeering a computer system. Malefactors seek to install malware by a variety of techniques, such as manipulating a user into clicking a link or opening an e-mail attachment that will result in installation of the malware on the user’s computer system, among other attack vectors. Once installed, certain types of malware will communicate surreptitiously with a server controlled by the malefactor. The data exchanged between the installed malware and the malefactor server is referred to as “command and control” data or “C2” data.

Behavioral models which aim to detect malware implants communicating from within a corporate computer network are difficult to test without true attacker-operated malicious activity. For obvious reasons, this is highly undesirable to have. As an organization becomes dependent on behavioral detection models or any other automated detective controls, the question of effectiveness and resilience to changes in attacker behavior becomes vital. As such, any responsible organization will need to ensure they are evaluating, testing, and otherwise continuously validating that the controls and models they deploy are operationally effective.

### SUMMARY

In one aspect, the present disclosure is directed to a method for detecting computer vulnerabilities. The method comprises automatically generating synthetic threat data representative of malicious activity, injecting the synthetic threat data into genuine data to create a composite data stream, observing a protective model that monitors the composite data stream to determine a failure by the protective model to detect the synthetic threat data, and, responsive to determining the failure, flagging the failure as a vulnerability.

In some embodiments, the malicious activity is command and control activity and the synthetic threat data is command and control data. In particular embodiments, automatically generating the synthetic threat data comprises automatically infecting a plurality of virtual machines with pseudo-malicious agents, wherein each of the virtual machines are connected to a simulated network, and automatically collecting simulated network traffic from the infected virtual machines, wherein the simulated network traffic contains communications from the pseudo-malicious agents. The pseudo-malicious agents may be generated by automatically specifying taskings for a plurality of tasking sets, automatically generating, from the specified taskings in the tasking sets, respective configuration files for each of the tasking sets, and automatically using the configuration files to derive the respective pseudo-malicious agents. In some such embodiments, automatically generating the synthetic threat data may further comprise manipulating the simulated network traffic to mimic genuine network traffic while retaining characteristics of the communications from the pseudo-malicious agents. In some specific implementations, infecting the plurality of virtual machines with the pseudo-malicious agents comprises using at least one endpoint detection and response (EDR) tool to inject the pseudo-malicious agents into the virtual machines.

In another aspect, the present disclosure is directed to a method for generating simulated network traffic containing simulated command and control data representative of malware activity. The method comprises automatically infecting a plurality of virtual machines with pseudo-malicious agents, wherein each of the virtual machines are connected to a simulated network, and automatically collecting simulated network traffic from the infected virtual machines, wherein the simulated network traffic contains communications from the pseudo-malicious agents. The pseudo-malicious agents are generated by automatically specifying taskings for a plurality of tasking sets, automatically generating, from the specified taskings in the tasking sets, respective configuration files for each of the tasking sets, and automatically using the configuration files to derive the respective pseudo-malicious agents.

In some embodiments, the methods further comprise manipulating the simulated network traffic to mimic genuine network traffic while retaining characteristics of the communications from the pseudo-malicious agents.

In some embodiments, infecting the plurality of virtual machines with the pseudo-malicious agents comprises using at least one endpoint detection and response (EDR) tool to inject the pseudo-malicious agents into the virtual machines.

In yet another aspect, the present disclosure is directed to a data processing system comprising at least one processor and memory coupled to the at least one processor, wherein the memory contains instructions which, when executed by the at least one processor, cause the data processing system to carry out any of the methods described above.

In a further aspect, the present disclosure is directed to at least one tangible, non-transitory computer-readable medium embodying instructions which, when executed by at least one processor of a data processing system comprising, cause the data processing system to carry out any of the methods described above.

### BRIEF DESCRIPTION OF THE DRAWINGS

These and other features will become more apparent from the following description in which reference is made to the appended drawings wherein:

FIG. 1 is a pictorial depiction of an illustrative method for detecting computer vulnerabilities according to an aspect of the present disclosure;

FIG. 2 is a pictorial depiction of an illustrative method for generating simulated network traffic containing simulated command and control data representative of malware activity, according to an aspect of the present disclosure;

FIG. 3 is a flow chart showing an illustrative method for detecting computer vulnerabilities according to an aspect of the present disclosure;

FIG. 4 is a flow chart showing an illustrative method for generating simulated network traffic containing simulated command and control data representative of malware activity, according to an aspect of the present disclosure; and

FIG. 5 is a block diagram of an illustrative computer system in respect of which aspects of the present disclosure may be implemented.

### DETAILED DESCRIPTION

The present disclosure describes systems, methods, and computer program products to generate true-positive command and control (C2) communication data, allowing protective models to be continuously tested and refined, thereby improving their capability in detecting malicious activity, such as malware.

It is possible to manually run adversarial emulation activities using a framework to infect a corporate system, and then record the telemetry from the corporate web proxy. This is only a single simulation and would require considerable manual effort. As such, this manual approach is difficult to scale. Systems and methods according to the present disclosure can run hundreds or even thousands of simulations per month with randomized parameters.

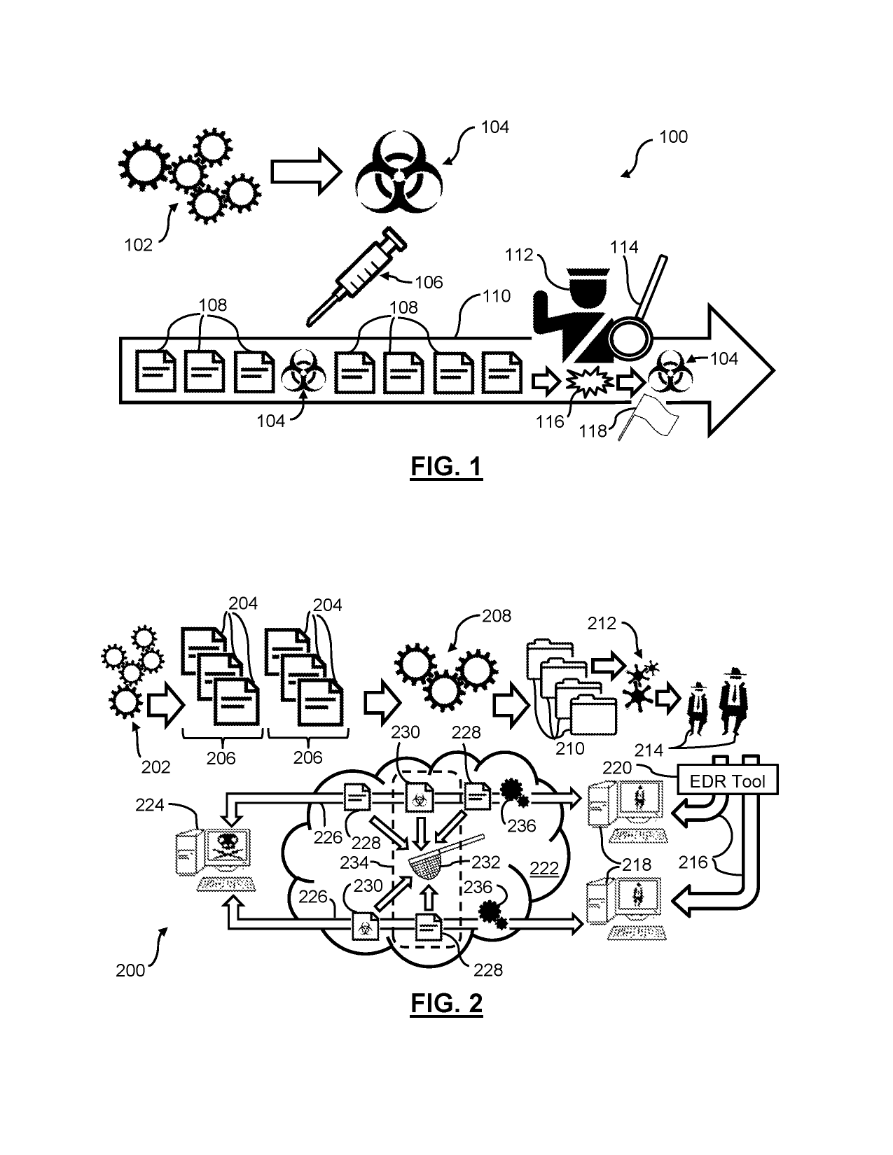

Reference is first made to FIG. 1, which is a pictorial depiction of an illustrative method 100 for detecting computer vulnerabilities according to an aspect of the present disclosure. The method 100 automatically generates 102 synthetic threat data 104. In one preferred embodiment, the synthetic threat data 104 is C2 data, although the method 100 may also be used with other types of synthetic threat data 104. The synthetic threat data 104 is preferably innocuous but is made to appear malicious. Preferably, the synthetic threat data 104 is entirely synthetic, and synthetic C2 data may be generated using the techniques described below in the context of FIG. 2. In other embodiments the synthetic threat data may incorporate or be adapted from genuine threat data (e.g. genuine C2 data).

The method 100 injects 106 the synthetic threat data 104 into genuine data 108 to create a composite data stream 110. By way of non-limiting illustrative example, in the case of network traffic flows, the synthetic threat data 104 is simulated network traffic and the genuine data 108 is genuine network traffic. The simulated network traffic is designed in such a way that it has the same general format as the genuine network traffic that is collected in the corporate network (typically using a tool such as a proxy server, for example). During injection, the synthetic threat data 104 is merged with the genuine network traffic, logically upstream of a protective model 112 (e.g. the analytics engine or security assessment tooling) so that protective model 112 receives a single composite data stream 110 comprising both the synthetic threat data 104 and the genuine data 108. The composite data stream 110 is monitored by a protective model 112. The network traffic data in the composite data stream 110 may comprise network packet data (e.g. PCAP files) that include the synthetic threat data 104 and the genuine data 108. In such embodiments, the protective model 112 may be an intrusion prevention system (IPS). Some non-limiting examples of IPS products include the SolarWinds® Security Event Manager (SEM) product offered by SolarWinds Worldwide, LLC having an address at 7171 Southwest Parkway, Building 400, Austin, TX 78735, the SNORT® and Secure IPS (Next-Generation Intrusion Prevention System or NGIPS) products offered by Cisco Technology, Inc. having an address at 170 West Tasman Drive, San Jose, CA 95134 and the Quantum™ security products offered by Check Point Software Technologies Ltd. having addresses at 100 Oracle Parkway, Suite 800, Redwood City, CA 94065 and 5 Ha'solelim Street, 6789705 Tel Aviv, Israel. The network traffic data in the composite data stream 110 may comprise proxy logs that include the synthetic threat data 104 and the genuine data 108. In such an embodiment, the protective model 112 may be, or may comprise, a system as described in United States Patent No. 12,126,638 the teachings of which are hereby incorporated by reference. The protective model 112 may, for example, include a statistical analysis of time differences between consecutive events coupled with heuristics for other indicators such as the number of unique users connecting to the destination, the total number of user agents employed, and other suitable indicators. Other suitable protective models may also be deployed.

The method 100 observes 114 the protective model 112 to determine a failure 116 by the protective model 112 to detect the synthetic threat data 104 in the composite data stream 110. In some embodiments, method 100 observes 114 the protective model 112 using a post-processing cross-check. For example, the protective model 112 will make “detections” that the protective model 112 assesses as likely (e.g. based on a likelihood threshold, which may be lower than a 50% probability depending on the desired sensitivity) to be malicious network traffic signals, and those flagged for investigation by security analysts. On a periodic basis, these “detections” are compared to the known list of synthetic threat data 104 to determine any discrepancies where the protective model 112 has not made a “detection” of the synthetic threat data 104. The comparison is preferably performed automatically, although a manual review and comparison is contemplated. In response to determining a failure 116 by the protective model 112 to detect the synthetic threat data 104, the method 100 flags 118 the failure 116 as a vulnerability. The method 100 may flag 118 the failure 118 in one or more ways, including an alert to human security personnel, such as by text or e-mail, an audible alarm, a visible alarm, or any combination of these. Alternatively, a periodic report listing the failures 118 may be generated and transmitted to the appropriate personnel.

In one preferred embodiment, the synthetic threat data 104 may be obtained by generating simulated network traffic containing simulated C2 data representative of malicious activity. Reference is now made to FIG. 2, which is a pictorial depiction of such a method, indicated generally at reference 200. The method 200 automatically specifies 202 the taskings 204 for a plurality of tasking sets 206, each comprising a plurality of taskings 204, to create a plurality of tasking sets 206. A tasking set 206 may comprise one or more taskings 204. The taskings 204 are actions that would commonly be associated with activities a malicious actor would be likely to carry out if they had access to an internal corporate asset. Some non-limiting examples of taskings 204 include taking screenshots of the victim computer system and sending them back to the C2 server, running local network scans to determine the network layout of the internal network and sending the results back to the C2 server, uploading additional malicious files to the victim computer system and executing them, and retrieving password hashes on the victim computer system and sending them to the C2 server for offline password cracking attempts. Two illustrative, non-limiting approaches for automatically specifying 202 the taskings 204 will now be described.

According to a first illustrative approach, an interface may be provided to explicitly specify some tasking details such as duration of the (simulated) malicious activity, number of simulated malware operations (such as taking screenshots, scanning network, and other expected activities by a threat actor that has installed a malware implant), measures of sleep time and specification of the operating system and browser to impersonate. The foregoing list of tasking details is merely illustrative and not limiting. A second illustrative approach uses a script (for example a Python script) to apply randomization to the specification of the above tasking details, to generate bulk taskings.

The method 200 automatically generates 208 two respective configuration files 210 for each tasking set 206. For each tasking set 206, one of the configuration files 210 is used for the creation of a synthetic malware implant, and the other configuration file 210 is an instruction script that the synthetic malware implant will use to direct its activity upon execution. In one embodiment, skeleton templates of the configuration files 210 are populated using the taskings 204 in the tasking sets 206 to arrive at configuration files that are unique to each iteration of the system. In one embodiment, the “jinja” library is used for generating 208 the populated configuration files 210. The “jinja” library is a Python library that supports the creation of a skeleton file with placeholders that are filled in using dynamically generated content during the run time of the program. As such, the specific configurations for the configuration files 210 are generated using randomized content filled in via the templating engine. The “jinja” library is available at https://jinja.palletsprojects.com/en/3.1.x/ under the 3-clause BSD license and is incorporated herein by reference.

After generating 208 the configuration files 210, the method then automatically uses the configuration files 210 to derive 212 a plurality of respective pseudo-malicious agents 214, with one pseudo-malicious agent 214 for each pair of configuration files 210. The pseudo-malicious agents 214 may be derived using either commercial or open source C2 frameworks. Examples of suitable C2 frameworks include, but are not limited to, Cobalt Strike® by Fortra, LLC having an address at 11095 Viking Drive, Suite 100, Eden Prairie, Minnesota 55344 (https://www.cobaltstrike.com/), Sliver Framework by Bishop Fox having an address at 1414 W Broadway Road, Suite 233, Tempe, AZ 85282 (https://bishopfox.com/tools/sliver), Nighthawk™ by MDSEC Consulting Ltd. having an address at 32A Park Green, Macclesfield, Cheshire, UK SK11 7NA (https://nighthawkc2.io/), and Mythic (https://docs.mythic-c2.net/). The configuration files 210 are inherent and specific to the C2 framework being deployed. For example, if the implementation used the Cobalt Strike C2 framework to simulate the attack sequences and communication channels, the skeleton templates of the configuration files 210 would be compatible with the expected configuration file format of Cobalt Strike. Thus, when the skeleton template is filled in with the randomly selected values, the resultant configuration file would be fully compatible and would allow the Cobalt Strike C2 framework to generate a pseudo-malicious agent 214 according to the chosen configuration values. It would also be possible to create an entirely custom implementation of a C2 framework for this purpose, however that would involve considerable development effort. The pseudo-malicious agents 214 are configured to, after installation on a computer system, send C2 data to and/or receive C2 data from another computer through a network. Thus, the pseudo-malicious agents 214 are simulated malware based on the respective configuration files 210, which are in turn based on the respective populated tasking sets 206.

The method 200 infects 216 a plurality of victim virtual machines 218 with the pseudo-malicious agents 214. The victim virtual machines 218 may be infected, for example, by using one or more remote interaction tools, scripts, or endpoint detection and response (EDR) tools 220 to inject the pseudo-malicious agents 214 into the victim virtual machines 218. Examples of suitable tools include, but are not limited to, PowerShell, Bash, and CrowdStrike Falcon Endpoint Protection Platform.

Each of the infected victim virtual machines 218 are connected to a simulated network 222, and an attacker virtual machine 224 is also connected to the simulated network 222. The simulated network may be configured, for example, to simulate a corporate network in respect of which the protective model 112 (FIG. 1) operates. Although only a single attacker virtual machine 224 is shown for purposes of illustration, there may be more than one attacker virtual machine 224. The infected victim virtual machines 218 generate simulated network traffic 226 through the simulated network 222. The simulated network traffic 226 results from the infected victim virtual machines 218 sending traffic to the attacker virtual machine 224 via the the simulated network 222. That simulated network traffic 226 is at least partially generated by the pseudo-malicious agents 214 running on the infected victim virtual machines 218, with the pseudo-malicious agents 214 having been configured pursuant to the tasking and configuration generated for the particular instantiation. The simulated network traffic 226 may contain both benign communications 228 from the infected victim virtual machines 218 as well as communications 230 from the pseudo-malicious agents 214 on the infected victim virtual machines 218 to the attacker virtual machine(s) 224. The communications 230 from the pseudo-malicious agents 214 may be, for example, C2 communications, and are an example of synthetic threat data. The simulated network traffic 226 from the infected victim virtual machines 218 is collected 232. For example, and without limitation, the simulated network traffic 226 may be captured via something like a proxy server or a packet capture tool and then merged with genuine network traffic. Thus, referring briefly to FIG. 1, the simulated network traffic 226 from the infected victim virtual machines 218 may be used as the synthetic threat data 104 that is injected 106 into the genuine data 108, which may be genuine network traffic. Referring again to FIG. 2, to facilitate collection 232, the simulated network traffic 226 may flow through a web proxy 234. Optionally, the method 200 may comprise aggregating and/or manipulating 236 the simulated network traffic 226 into an expected format to mimic genuine network traffic while retaining characteristics of the communications 230 from the pseudo-malicious agents 214.

As shown pictorially in FIG. 2, each of the pseudo-malicious agents 214 has different characteristics, which may be configured by random selection within constraints set by an operator. The method 200 shown in FIG. 2 may be carried out serially for each of the pseudo-malicious agents 214, or in parallel, or a combination of the two (e.g. sets of two or more of the pseudo-malicious agents 214 may operate in parallel, with serial evaluation of respective sets of the pseudo-malicious agents 214).

A backend service orchestrator may be responsible for managing the simulation engine. The simulation engine may create randomized configurations for each simulation (subject to constraints selected by an operator) and manage the creation and staging of the pseudo-malicious agents 214 as well as the infection 216. The backend service orchestrator may obtain the skeleton templates, select the random values for the taskings 204 and configuration files 210, create the actual configuration files 210 and use them to generate the pseudo-malicious agents 214, force the infected victim virtual machines 218 to run the code for the pseudo-malicious agents 214. The backend service orchestrator may also manage the attacker virtual machine(s) 224 and the simulated network traffic 226 through the simulated network 222, including collection of the network traffic logs/signals so it can be pushed or merged into the genuine data flow (i.e. injecting 106 the synthetic threat data 104 into genuine data 108 to create a composite data stream 110 for the protective model 112 to examine, as in FIG. 1). A log manipulation process may be used to take logs from the web proxy 234 or a DNS server and then position them with an API for remote retrieval into a data model analysis pipeline.

Although the above description has referred to the use of virtual machines 218, 224 and a simulated network 222 as a preferred embodiment for reasons of efficiency, the method 200 shown in FIG. 2 may also be implemented with individual physical computers communicating over an actual physical network.

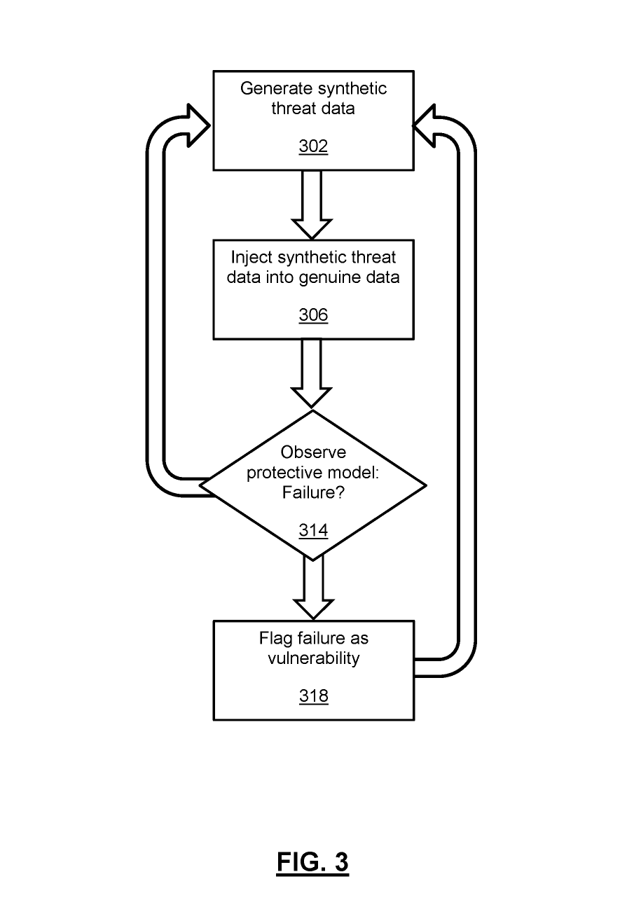

In further illustration, FIG. 3 is a flow chart showing an illustrative method 300 for detecting computer vulnerabilities. At step 302, the method 300 automatically generates synthetic threat data representative of malicious activity. In preferred embodiments, the malicious activity is command and control activity and the synthetic threat data is command and control data. The synthetic threat data is preferably entirely synthetic, and may comprise simulated network traffic. At step 306, the method 300 injects the synthetic threat data into genuine data to create a composite data stream. Where the synthetic threat data comprises simulated network traffic, the genuine data may comprise genuine network traffic, and step 306 may comprise injecting the simulated network traffic into the genuine network traffic. Prior to injection, the simulated network traffic may be manipulated to mimic the genuine network traffic. At step 314, the method 300 observes a protective model that monitors the composite data stream to determine a failure by the protective model to detect the synthetic threat data. If no such failure is determined (“no” at step 314), the method 300 returns to step 302. Responsive to determining a failure by the protective model to detect the synthetic threat data (“yes” at step 314), the method 300 proceeds to step 318 and flags the failure as a vulnerability, and then returns to step 302.

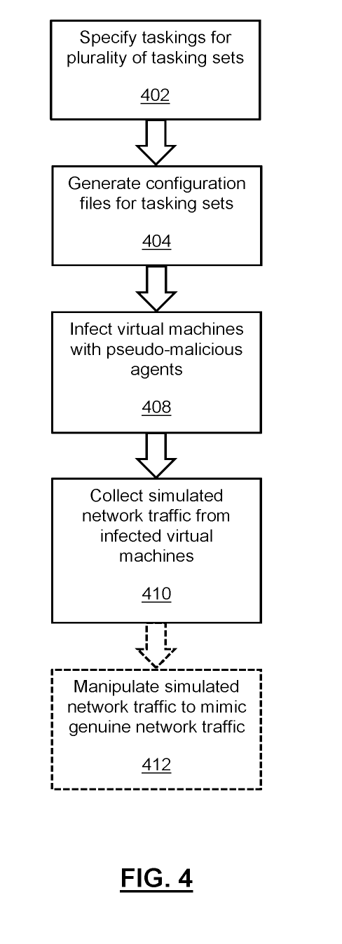

Reference is now made to FIG. 4, which is a flow chart showing an illustrative method 400 for generating simulated network traffic containing simulated command and control data representative of malware activity. The method 400 is an illustrative implementation of step 302 of the method 300.

At step 402, the method 400 automatically specifies taskings for a plurality of tasking sets. The taskings are actions that would commonly be associated with activities a malicious actor would be likely to carry out if they had access to an internal corporate asset. At step 404, the method 400 automatically generates, from the specified taskings in the tasking sets, respective configuration files for each of the tasking sets. At step 406, the method 400 automatically uses the configuration files to derive respective pseudo-malicious agents. Next, at step 408, the method 400 automatically infects a plurality of virtual machines with the pseudo-malicious agents, with each of the virtual machines being connected to a simulated network. The virtual machines may be infected with the pseudo-malicious agents by using at least one endpoint detection and response (EDR) tool to inject the pseudo-malicious agents into the virtual machines. At step 410, the method 400 automatically collects simulated network traffic from the infected virtual machines. The simulated network traffic collected at step 410 contains communications from the pseudo-malicious agents. At optional step 412, the method 400 manipulates the simulated network traffic to mimic genuine network traffic while retaining characteristics of the communications from the pseudo-malicious agents.

While the method 100 shown in FIG. 1 is particularly suitable where the malicious activity is C2 activity and the synthetic threat data 104 is C2 data, it is not necessarily limited to such applications. For example, in other embodiments the method 100 shown in FIG. 1 can be applied where the malicious activity is delivery of a malicious computer payload with the synthetic threat data 104 being representative of the delivery of a malicious computer payload.

As can be seen from the above description, the vulnerability detection and synthetic threat data generation methods described herein represent significantly more than merely using categories to organize, store and transmit information and organizing information through mathematical correlations. The vulnerability detection and synthetic threat data generation methods are in fact an improvement to the technology of computer security, and to the technology of vulnerability testing in particular, as the methods provide for a substantial increase in the scale at which vulnerability testing can be performed. As such, the vulnerability detection and synthetic threat data generation methods are confined to computer security applications, and in particular to vulnerability testing. Thus, the present disclosure is directed to the resolution of a computer problem, specifically how to perform large-scale vulnerability testing of a protective model in a computer network without an impractical amount of manual effort. Aspects of the present disclosure improve the functionality of computer vulnerability testing systems by increasing the scale at which the computer vulnerability testing systems can operate. Key features of the present disclosure describe and enable automation of the the generation of synthetic threat data and automation of the application of such synthetic threat data to vulnerability testing. This automation obviates the requirement for mental processes involved in manually running adversarial emulation activities using a framework to infect a corporate system. Importantly, however, the present disclosure is not directed merely to the automation of a manual process by generic computer processing of mathematical calculations, but describes specific functional computer technology that enables the automation. Furthermore, the human mind is not equipped to inject synthetic threat data into genuine data to create a composite data stream, or to infect a plurality of virtual machines with pseudo-malicious agents and collect simulated network traffic from the infected virtual machines; these are activities that are unique to computers and by their very nature require computer implementation – they exist only in the context of a computer system. Computer vulnerability testing itself exists only in the context of operational computer systems.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

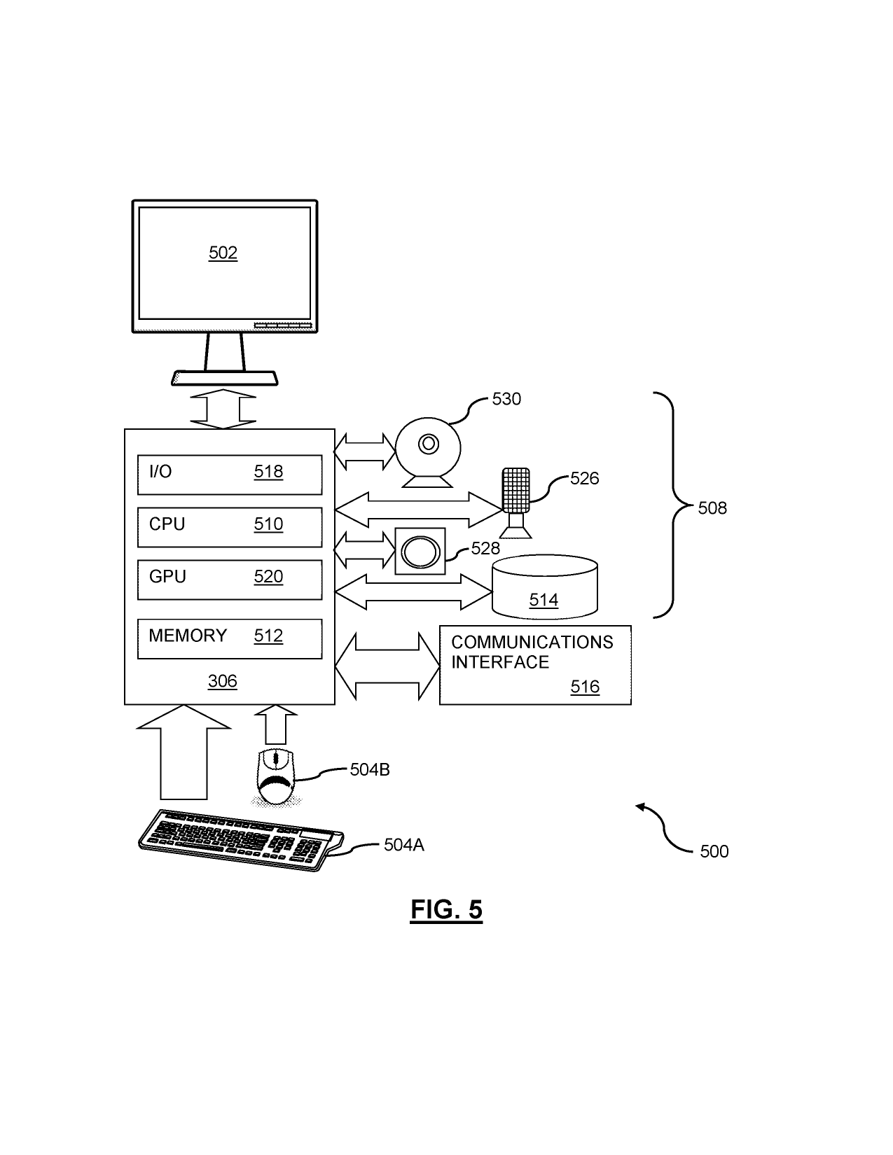

An illustrative computer system in respect of which the technology herein described may be implemented is presented as a block diagram in FIG. 5. The illustrative computer system is denoted generally by reference numeral 500 and includes a display 502, input devices in the form of keyboard 504A and pointing device 504B, computer 506 and external devices 508. While pointing device 504B is depicted as a mouse, it will be appreciated that other types of pointing device, or a touch screen, may also be used.

The computer 506 may contain one or more processors or microprocessors, such as a central processing unit (CPU) 510. The CPU 510 performs arithmetic calculations and control functions to execute software stored in an internal memory 512, preferably random access memory (RAM) and/or read only memory (ROM), and possibly additional memory 514. The additional memory 514 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 514 may be physically internal to the computer 506, or external as shown in FIG. 5, or both.

The computer system 500 may also include other similar means for allowing computer programs or other instructions to be loaded. Such means can include, for example, a communications interface 516 which allows software and data to be transferred between the computer system 500 and external systems and networks. Examples of communications interface 516 can include a modem, a network interface such as an Ethernet card, a wireless communication interface, or a serial or parallel communications port. Software and data transferred via communications interface 516 are in the form of signals which can be electronic, acoustic, electromagnetic, optical or other signals capable of being received by communications interface 516. Multiple interfaces, of course, can be provided on a single computer system 500.

Input and output to and from the computer 506 is administered by the input/output (I/O) interface 518. This I/O interface 518 administers control of the display 502, keyboard 504A, external devices 508 and other such components of the computer system 500. The computer 506 also includes a graphical processing unit (GPU) 520. The latter may also be used for computational purposes as an adjunct to, or instead of, the (CPU) 510, for mathematical calculations.

The external devices 508 include a microphone 526, a speaker 528 and a camera 530. Although shown as external devices, they may alternatively be built-in as part of the hardware of the computer system 500.

The various components of the computer system 500 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 512 of the computer 506, or on a computer usable or computer readable medium external to the computer 506, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A computer-implemented method for detecting computer vulnerabilities, comprising:
automatically generating synthetic threat data representative of malicious activity;
injecting the synthetic threat data into genuine data to create a composite data stream;
observing a protective model that monitors the composite data stream to determine a failure by the protective model to detect the synthetic threat data; and
responsive to determining the failure, flagging the failure as a vulnerability.

2. The method of claim 1, wherein the malicious activity is command and control
activity and the synthetic threat data is command and control data.

3. The method of claim 2, wherein automatically generating the synthetic threat data comprises:
automatically infecting a plurality of virtual machines with pseudo-malicious agents, wherein
each of the virtual machines are connected to a simulated network; and
automatically collecting simulated network traffic from the infected virtual machines, wherein the simulated network traffic contains communications from the pseudo-malicious agents;
wherein the synthetic threat data comprises the simulated network traffic.

4. The method of claim 3, wherein the pseudo-malicious agents are generated by:
automatically specifying taskings for a plurality of tasking sets;
automatically generating, from the specified taskings in the tasking sets, respective configuration files for each of the tasking sets;
automatically using the configuration files to derive the respective pseudo-malicious agents.

5. The method of claim 3, further comprising manipulating the simulated network traffic to mimic genuine network traffic while retaining characteristics of the communications from the pseudo-malicious agents.

6. The method of claim 3, wherein infecting the plurality of virtual machines with the
pseudo-malicious agents comprises using at least one endpoint detection and response (EDR) tool to inject the pseudo-malicious agents into the virtual machines.

7. The method of claim 3, wherein:
the genuine data comprises genuine network traffic; and
injecting the synthetic threat data into the genuine data to create the composite data stream comprises injecting the simulated network traffic into the genuine network traffic.

8. The method of claim 1, wherein the synthetic threat data is entirely synthetic.

9. A data processing system comprising at least one processor and memory coupled to the at least one processor, wherein the memory contains instructions which, when executed by the at least one processor, cause the data processing system to carry out the method of claim 1.

10. At least one tangible, non-transitory computer-readable medium embodying instructions which, when executed by at least one processor of a data processing system, cause the data processing system to carry out the method of claim 1.

11. A computer-implemented method for generating simulated network traffic containing simulated command and control data representative of malware activity, the method comprising:
automatically infecting a plurality of virtual machines with pseudo-malicious agents, wherein each of the virtual machines are connected to a simulated network; and
automatically collecting simulated network traffic from the infected virtual machines, wherein the simulated network traffic contains communications from the pseudo-malicious agents.

12. The method of claim 11, wherein the pseudo-malicious agents are generated by:
automatically specifying taskings for a plurality of tasking sets;
automatically generating, from the specified taskings in the tasking sets, respective configuration files for each of the tasking sets;
automatically using the configuration files to derive the respective pseudo-malicious agents.

13. The method of claim 11, further comprising manipulating the simulated network
traffic to mimic genuine network traffic while retaining characteristics of the communications from the pseudo-malicious agents.

14. The method of claim 11, wherein infecting the plurality of virtual machines with the pseudo-malicious agents comprises using at least one endpoint detection and response (EDR) tool to inject the pseudo-malicious agents into the virtual machines.

15. A data processing system comprising at least one processor and memory coupled to the at least one processor, wherein the memory contains instructions which, when executed by the at least one processor, cause the data processing system to carry out the method of claim 11.

16. At least one tangible, non-transitory computer-readable medium embodying instructions which, when executed by at least one processor of a data processing system, cause the data processing system to carry out the method of claim 11.
